(19) United States
(12) Patent Application Publication
(10) Pub. No.: US 2019/0311517 A1
(43) Pub. Date: Oct. 10, 2019

(54) DATA PROCESSING SYSTEM INCLUDING AN EXPANDED MEMORY CARD

(71) Applicant: SK hynix Inc., Icheon-si Gyeonggi-do (KR)

(72) Inventor: Nam-Young AHN, Seoul (KR)

(73) Assignee: SK hynix Inc., Icheon-si Gyeonggi-do (KR)

(21) Appl. No.: 16/151,602

(22) Filed: Oct. 4, 2018

(30) Foreign Application Priority Data
Apr. 4, 2018 (KR) 10-2018-0038975

(51) Int. Cl. G06T 15/00; G06F 9/38; G06F 13/28; G06T 1/20

(52) U.S. Cl. CPC G06T 15/005; G06F 9/3877; G06F 9/3822; G06T 1/20; G06F 13/28

(57) ABSTRACT

A data processing system, and a method of operating the same, includes a first processing unit and a first memory unit. The data processing system also includes an assistant card having a second processing unit and a second memory unit and an expanded card having a third memory unit. The data processing system further includes a first interface that supports communication between the main card and the assistant card, a second interface that supports communication between the main card and the expanded card, and a third interface that supports communication between the assistant card and the expanded card.

### CROSS-REFERENCE TO RELATED APPLICATIONS

The present application claims priority under 35 U.S.C. § 119(a) to Korean Patent Application No. 10-2018-0038975, filed on Apr. 4, 2018, the disclosure of which is incorporated herein by reference in its entirety.

### BACKGROUND

### 1. Technical Field

Various embodiments may generally relate to a data processing system. Particularly, the embodiments may relate to a data processing system capable of processing data by using an expanded memory system.

### 2. Related Art

The use of large-capacity parallel processing, such as machine learning and MapReduce, is increasing. Therefore, the demand for technology to rapidly process large amounts of data is increasing.

A graphics processing unit (GPU) is a processor whose main purpose is to accelerate graphics processing. As the quality of 3D graphics improves, for example, higher graphics processing power is required. Taking advantage of internal parallelism allows GPUs to perform computationally intensive graphics tasks.

Due to the high degree of parallelism in GPUs, mass computation and GPU programming environments have come into existence. GPUs are being used not only for graphics processing but also for large-capacity data processing.

In order for GPUs to process large amounts of data rapidly, it is necessary to improve the data processing capabilities of data processing systems using the GPUs for data processing.

### SUMMARY

In accordance with the present teachings is a data processing system including a main card including a first processing unit and a first memory unit. The data processing system also includes an assistant card having a second processing unit and a second memory unit, and an expanded card having a third memory unit. The data processing system further includes a first interface that supports communication between the main card and the assistant card, a second interface that supports communication between the main card and the expanded card, and a third interface that supports communication between the assistant card and the expanded card.

Also in accordance with the present teachings is an operating method of a data processing system. The method includes sending, by a first processing unit of the data processing system, a command to a second processing unit of the data processing system through a first interface and sending, by the first processing unit, input data to an third memory unit of the data processing system through a second interface. The method also includes receiving, by the second processing unit, the input data from the third memory unit through a third interface, processing the input data in response to the command to generate process data, and sending the process data to the third memory unit through the third interface. The method further includes receiving, by the first processing unit, the process data from the third memory unit through the second interface.

### BRIEF DESCRIPTION OF THE DRAWINGS

FIG. 1 shows a block diagram illustrating a data processing system, in accordance with an embodiment of the present teachings.

FIG. 2 shows a block diagram illustrating a configuration of a data processing system, in accordance with an embodiment of the present teachings.

FIG. 3 shows a block diagram illustrating a configuration of a data processing system in accordance with an embodiment of the present teachings.

FIGS. 4 to 7 show flow diagrams illustrating a parallel data processing operation of a data processing system, in accordance with embodiments of the present teachings.

FIGS. 8 to 10 show perspective diagrams illustrating physical configurations of a data processing system, in accordance with embodiments of the present teachings.

### DETAILED DESCRIPTION

Various embodiments of the present teachings are described below in detail with reference to the accompanying drawings. We note, however, that the present teachings may be embodied in different other embodiments different from those presented herein. Therefore, presented embodiments should not be construed as being limiting. Rather, a limited number of embodiments are described to convey the present teachings to those skilled in the art. Throughout the disclosure, like reference numerals refer to like parts throughout the various figures and embodiments of the present teachings.

It will be understood that, although the terms “first,” “second,” “third,” and so on may be used herein to describe various elements, these elements are not limited by these terms. These terms are used to distinguish one element from another element. Thus, a first element described below could also be termed as a second or third element without departing from the spirit and scope of the present teachings.

The drawings are not necessarily to scale and, in some instances, proportions may be exaggerated in order to clearly illustrate features of presented embodiments. When one element is referred to as being connected or coupled to another element, it should be understood that the one element can be directly connected or coupled to the other element or electrically connected or coupled to the other element via one or more intervening element between the one element and the other element.

It will be further understood that when one element is referred to as being “connected to” or “coupled to” another element, the one element may be directly on, connected to, or coupled to the other element, or one or more intervening elements may be present between the one element and the other element. In addition, it will also be understood that when an element is referred to as being “between” two elements, it may be the only element between the two elements, or one or more intervening elements may also be present.

The terminology used herein is for the purpose of describing particular embodiments only and is not intended to limit other possible embodiments.

As used herein, singular forms are intended to include the plural forms as well, unless the context clearly indicates otherwise.

It will be further understood that the terms “comprises,” “comprising,” “includes,” and “including,” when used in this specification, specify the presence of the stated elements and do not preclude the presence or addition of one or more other elements. As used herein, the term “and/or” includes any and all combinations of one or more of listed or implied items.

Unless otherwise defined, all terms including technical and scientific terms used herein have the same meaning as commonly understood by one of ordinary skill in the art to which the present teachings belong in view of the present disclosure. It will be further understood that terms, such as those defined in commonly used dictionaries, should be interpreted as having a meaning that is consistent with their meaning in the context of the present disclosure and the relevant art, and that the terms will not be interpreted in an idealized or overly formal sense unless expressly so defined herein.

In the following description, numerous specific details are set forth in order to send an understanding of the present teachings. The present teachings may be practiced without some or all of these specific details presented. In other instances, well-known process structures and/or processes have not been described in detail in order not to unnecessarily obscure a described feature of the present teachings.

It is also noted, that in some instances, as would be apparent to those skilled in the relevant art, a feature or element described in connection with one embodiment may be used singly or in combination with other features or elements of another embodiment, unless otherwise specifically indicated.

Various embodiments of the present teachings are directed to a data processing system including a first processing unit, a second processing unit that supports performance of the first processing unit, and a third memory unit accessed by the first processing unit and the second processing unit through an interface.

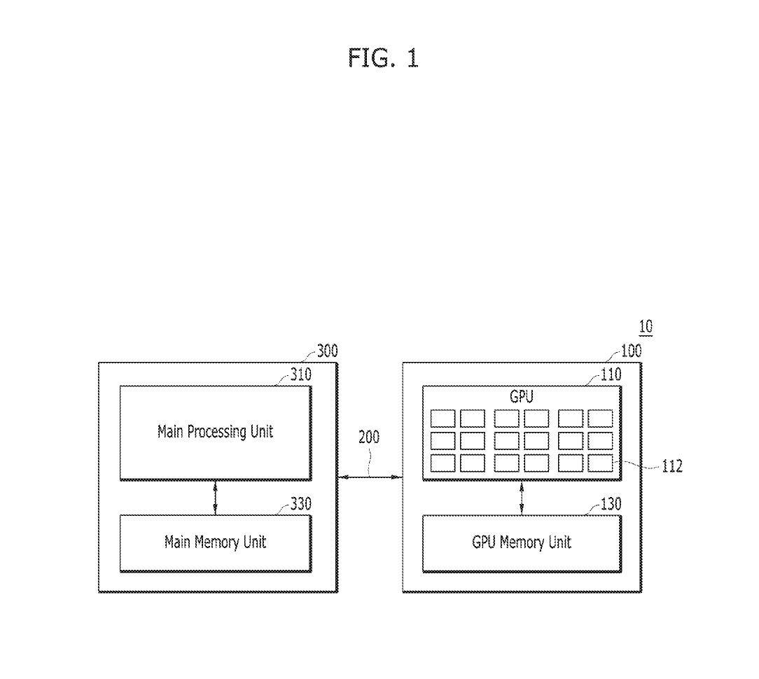

FIG. 1 shows a block diagram illustrating a data processing system 10.

Referring to FIG. 1, the data processing system 10 may include a graphics card 100 and a main card 300. The main card 300 includes a main processing unit 310 and a main memory unit 330. The graphics card 100 includes a graphics processing unit (GPU) 110 and a GPU memory unit 130. The GPU 110 includes a plurality of operating cores 112 for parallel processing of data.

The graphics card 100 and the main card 300 may communicate with each other through an interface 200. The main processing unit 310 and the main memory unit 330 communicate with each other inside the main card 300, and the GPU 110 and the GPU memory unit 130 communicate with each other inside the graphics card 100.

The GPU is a processor directed to accelerating graphics processing. As the quality of 3D graphics increases, for example, higher graphics processing power is required, and therefore, the internal parallelism of the GPU is increased to perform computationally intensive graphics tasks. Due to the high degree of parallelism of the GPU, mass computation is easy and a GPU programming environment is developed, the GPU is being used not only for graphics processing but also for large-capacity data processing.

The interface 200 may be a high-speed communication interface such as peripheral component interconnect express (PCIe).

The main processing unit 310 sends a command to the GPU 110 through the interface 200. The main processing unit 310 may send input data stored in the main memory unit 330 to the GPU memory unit 130 through the interface 200. Input data refers to data that the GPU 110 has to process corresponding to a command.

The GPU 110 processes the input data in response to the command. The operating cores 112 included in the GPU 110 may process in parallel data stored in the GPU memory unit 130.

As the GPU 110 sends process data processed by the GPU 110 to the main memory unit 330 through the interface 200, a parallel data processing operation of the data processing system 10 is completed.

The size of the GPU memory unit 130 may be dictated according to specifications of the graphics card 100. For example, as a standard of the graphics card 100, the amount of memory may be limited. Accordingly, a bottleneck phenomenon may occur in a process of sending data from the main memory unit 330 to the GPU memory unit 130 or sending data from the GPU memory unit 130 to the main memory unit 330. The GPU memory unit 130 having a limited size limits a unit size of data sent between the main memory unit 330 and the GPU memory unit 130. The bottleneck phenomenon may result in the overall performance of the data processing system 10 being greatly reduced regardless of the performance of the GPU 110.

That is, the performance of the data processing system 10 may be degraded because of the GPU memory unit 130 having limited memory, independent of the processing capacity of the GPU 110.

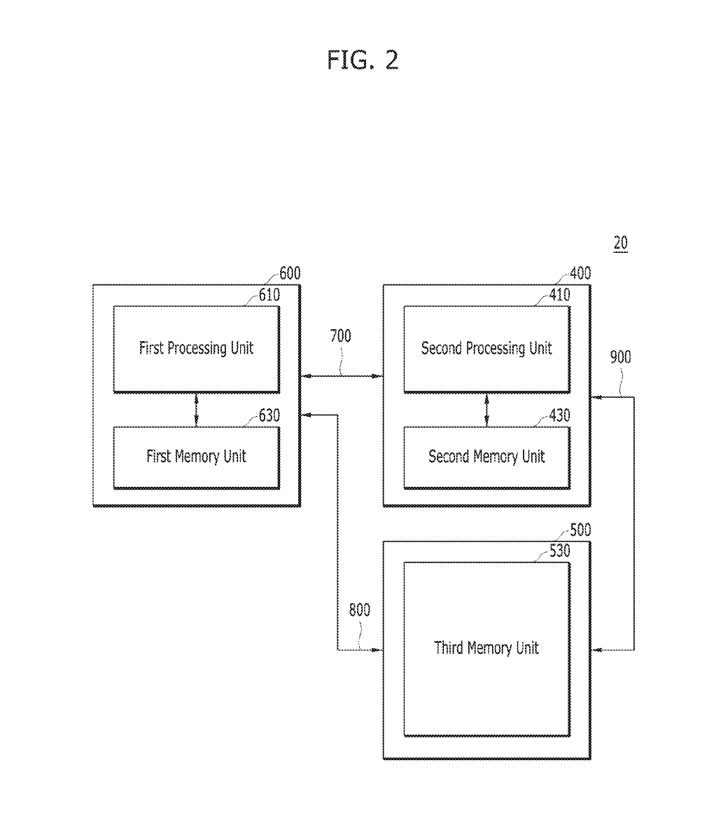

FIG. 2 shows a block diagram illustrating an exemplary configuration of a data processing system 20, in accordance with an embodiment of the present teachings.

The data processing system 20 may include an assistant card 400, an expanded card 500, and a main card 600. The main card 600 may include a first processing unit 610 and a first memory unit 630. The assistant card 400 may include a second processing unit 410 and a second memory unit 430. The second processing unit 410 may include a plurality of operating cores for parallel processing of data.

The assistant card 400 and the main card 600 may communicate with each other through a first interface 700. The first processing unit 610 and the first memory unit 630 may communicate with each other inside the main card 600. The second processing unit 410 and the second memory unit 430 may communicate with each other inside the assistant card 400.

The expanded card 500 may include a third memory unit 530. The third memory unit 530 may be a memory system including an expanded memory controller and an expanded memory device. In addition to the second memory unit 430, the third memory unit 530 may store input data that the second processing unit 410 has to process corresponding to a command and process data processed by the second processing unit 410. Specifically, the expanded memory controller may send an internal command to control the expanded memory device, and the expanded memory device may store the input data and the process data.

The expanded card 500 may communicate with the main card 600 through a second interface 800, and may communicate with the assistant card 400 through a third interface 900.

As the input data and the process data are stored in the third memory unit 530 of the expanded card 500 as well as in the second memory unit 430, a size of data that the second processing unit 410 may process at a time in the data processing system 20 including the second processing unit 410 may increase.

According an embodiment of the present teachings, the second processing unit 410 may be a graphics processing unit (GPU).

According an embodiment of the present teachings, the assistant card 400 may be a graphics card.

According an embodiment of the present teachings, the first interface 700 may be a high-speed communication interface, such as PCIe.

According an embodiment of the present teachings, the second interface 800 may be a high-speed communication interface, such as PCIe.

When the data processing system 20 is booted up, the first processing unit 610 may recognize the assistant card 400 and the expanded card 500 through information of a basic input output system (BIOS) of the main card 600.

The first processing unit 610 may access the assistant card 400 and the expanded card 500 through memory mapped input and output (MMIO). The MMIO is an input and output (input/output or I/O) scheme in which a register of an input/output device is treated as a memory and an address space of the memory is allocated for the register so that a processor accesses the register in the same manner as when accessing the memory.

Specifically, the first processing unit 610 may allocate an address space of the first memory unit 630 for a register of the assistant card 400 and expanded card 500. Consequently, the first processing unit 610 may access the assistant card 400 and the expanded card 500 in the same manner as when accessing the first memory unit 630.

The first processing unit 610 may send a command to the second processing unit 410 through the MMIO.

The first processing unit 610 may send input data stored in the first memory unit 630 to the assistant card 400. The second processing unit 410 may receive the input data and store the input data in the second memory unit 430.

The first processing unit 610 may send the input data stored in the first memory unit 630 to the third memory unit 530.

The first processing unit 610 may notify the second processing unit 410 through the MMIO that the input data is sent to the second memory unit 430 and/or the third memory unit 530. The second processing unit 410 may notify the first processing unit 610 through the MMIO that data processing is completed.

The first processing unit 610 may receive the process data stored in the second memory unit 430 and/or the third memory unit 530 and store the received process data in the first memory unit 630.

One of the ways in which the assistant card 400 and the expanded card 500 access the first memory unit 630 is a direct memory access (DMA). The DMA is a function that allows peripheral devices such as a graphics card to directly access a memory. For example, the assistant card 400 and the expanded card 500 may directly access a frame buffer of the first memory unit 630 through a DMA controller.

According to an embodiment of the present teachings, a data exchange operation may be performed between the assistant card 400 or the expanded card 500 and the first memory unit 630 through the DMA controller physically included in the data processing system 20 separately from the first processing unit 610. According an embodiment of the present teachings, the DMA controller may be included in the first processing unit 610, and the data exchange operation between the assistant card 400 or the expanded card 500 and the first memory unit 630 may be performed under control of the DMA controller included in the first processing unit 610.

Although the DMA controller is physically included separately from the first processing unit 610, it may be understood that the DMA controller is functionally included in or collocated with the first processing unit 610.

In some embodiments consistent with the present teachings, the data exchange operation between the assistant card 400 or the expanded card 500 and the first memory unit 630 is performed under the control of the first processing unit 610, regardless of the physical and functional locations of the DMA controller.

According to an embodiment of the present teachings, the third interface 900 may be a high-speed communication interface such as PCIe. The second processing unit 410 may send a command and a packet including memory address information to perform the command to the expanded memory controller of the third memory unit 530 through the third interface 900. The command may include write, read, erase, and/or flush commands. The expanded memory controller may parse a structure of the sent packet and control an operation of the expanded memory device in response to the command.

Although FIG. 2 illustrates that the data processing system 20 includes one assistant card 400 and one expanded card 500, different combinations of one or more of the main card 600, one or more of the assistant card 400, and one or more of the expanded card 500 may be included in the data processing system 20. For these combinations, one or more of the first to third interfaces 700 to 900 may be included in plural depending on the number of cards included in the data processing system 20.

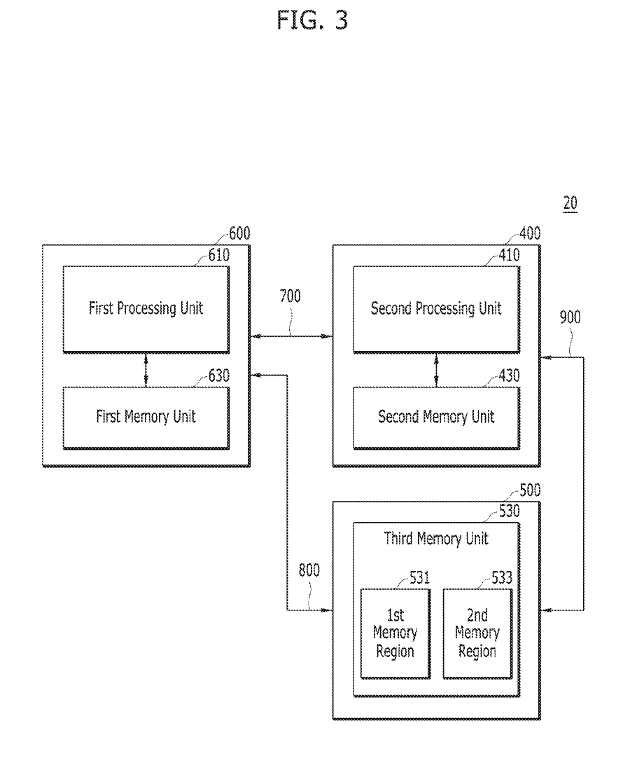

FIG. 3 shows a block diagram illustrating an exemplary configuration of the data processing system 20 of FIG. 2, in accordance with an embodiment of the present teachings.

Referring to FIG. 3, the third memory unit 530 may include a first memory region 531 and a second memory region 533. The first memory region 531 is a region in which the input data sent by the first processing unit 610 is stored, and the second memory region 533 is a region in which the process data processed by the second processing unit 410 is stored

The expanded memory controller may notify the first processing unit 610 through the MMIO that the process data is stored in the second memory region 533.

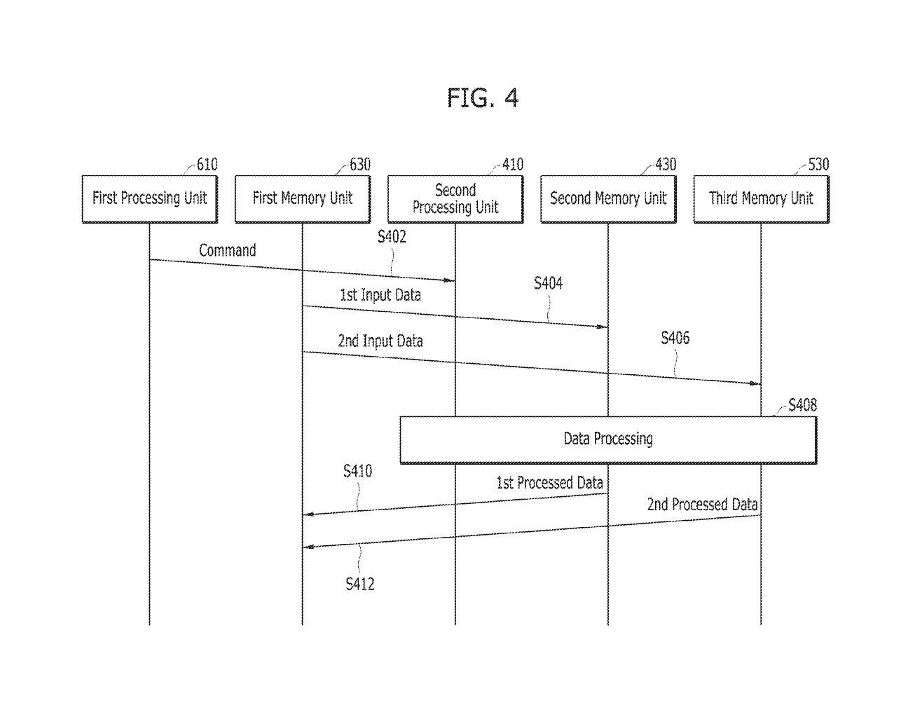

FIG. 4 shows a flow diagram illustrating a parallel data processing operation of the data processing system 20, in accordance with an embodiment of the present teachings.

The first processing unit 610 sends S402 a command to the second processing unit 410 through the first interface 700.

The first processing unit 610 may divide input data stored in the first memory unit 630 into first input data and second input data. The first input data is based on a capacity of the second memory unit 430. The remaining data that exceeds the capacity of the second memory unit 430 is the second input data. The first processing unit 610 may send S404 the first input data to the second memory unit 430 through the first interface 700, and may send the second input data to the third memory unit 530 through the second interface 800.

The second processing unit 410 receives and processes S408 the first and second input data sent to the second memory unit 430 and the third memory unit 530, in response to the command. The plurality of operating cores included in the second processing unit 410 may process in parallel the first and second input data.

The second memory unit 430 and the third memory unit 530 may operate as a single memory space that the second processing unit 410 may access. The second processing unit 410 may access data stored in the third memory unit 530 through the third interface 900 to process the second input data.

The second processing unit 410 may send first and second process data generated by processing the first and second input data to the second memory unit 430 and the third memory unit 530, respectively

The second processing unit 410 may enable the first processing unit 610 to recognize that data processing is completed. For example, as described above, an address space of the first memory unit 630 may be allocated for a register of the assistant card 400. When the second processing unit 410 indicates that the data processing is completed using the register, the first processing unit 610 may access the register through MMIO and recognize that the data processing is completed.

As the second processing unit 410 sends an interruption to the first processing unit 610, the second processing unit 410 may notify the first processing unit 610 that the data processing is completed.

For operations S410 and S412, the first processing unit 610 may receive the first and second process data through the first and second interfaces 700 and 800, respectively, and store the first and second process data in the first memory unit 630. Consequently, the parallel data processing operation of the data processing system 20 may be completed.

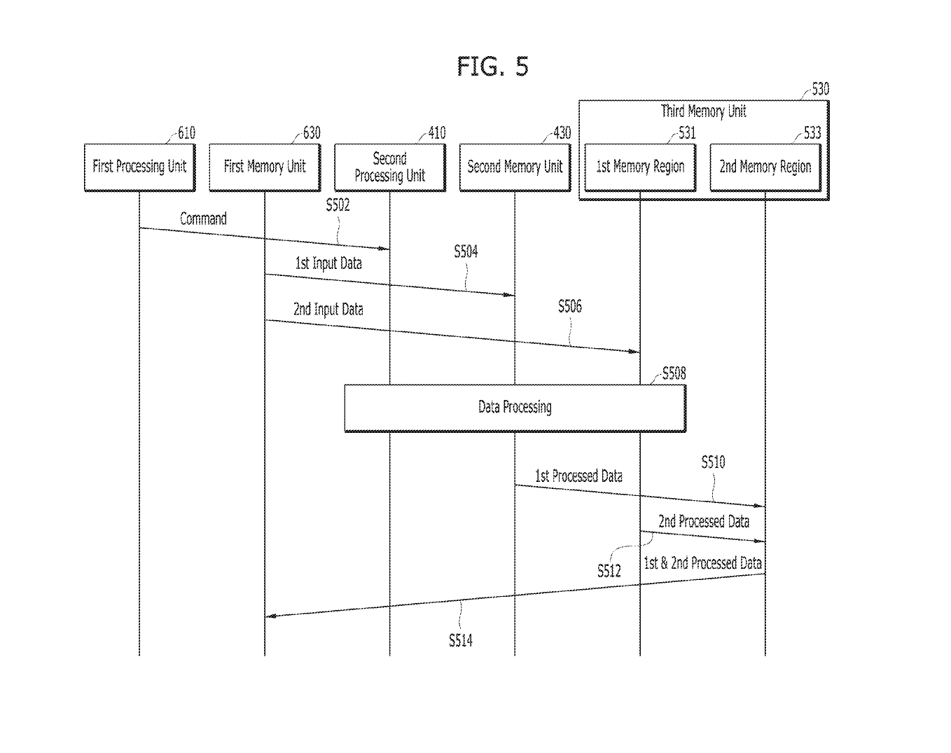

FIG. 5 shows a flow diagram illustrating a parallel data processing operation of the data processing system 20, in accordance with an embodiment of the present teachings.

Referring to FIG. 5, the first processing unit 610 sends S502 a command to the second processing unit 410 through the first interface 700.

The first processing unit 610 may divide input data stored in the first memory unit 630 into first input data and second input data. The first input data is based on a capacity of the second memory unit 430. The remaining data that exceeds the capacity of the second memory unit 430 is the second input data. The first processing unit 610 may send the first input data to the second memory unit 430 through the first interface 700, and may send the second input data to the first memory region 531 of the third memory unit 530 through the second interface 800.

The second processing unit 410 receives and processes S508 the first and second input data sent to the second memory unit 430 and the first memory region 531 in response to the command.

The second memory unit 430 and the third memory unit 530 may operate as a single memory space that the second processing unit 410 may access.

For operations S510 and S512, the second processing unit 410 may send first and second process data generated by processing the first and second input data, respectively, to the second memory region 533 of the third memory unit 530.

The expanded memory controller may enable the first processing unit 610 to recognize that the first and second process data are stored in the second memory region 533. For example, as described above, an address space of the first memory unit 630 may be allocated for a register of the expanded card 500. When the expanded memory controller indicates that the first and second process data are stored in the second memory region 533 using the register, the first processing unit 610 may access the register through MMIO and recognize that the first and second process data are stored in the second memory region 533.

As the expanded memory controller sends an interruption to the first processing unit 610, the expanded memory controller may notify the first processing unit 610 that the first and second process data are stored in the second memory region 533.

The first processing unit 610 may receive S514 the first and second process data through the second interface 800 and store S514 the first and second process data in the first memory unit 630.

According to an embodiment of the present teachings, the first processing unit 610 may receive the first and second process data stored in the second memory region 533 even during processing of the first and second input data.

Consequently, the parallel data processing operation of the data processing system 20 may be completed.

In this case, since only the second interface 800 carries out provision of the first and second process data, the provision of the command and input data between the assistant card 400 and the main card 600 through the first interface 700 is not affected by the provision of the first and second process data. Therefore, performance of the data processing system 20 may be improved.

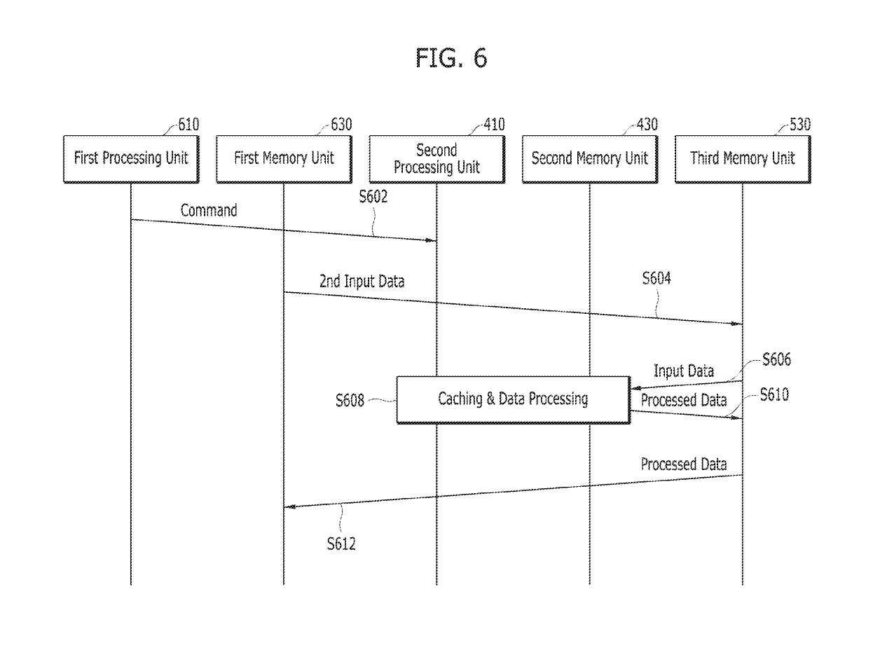

FIG. 6 shows a flow diagram illustrating a parallel data processing operation of the data processing system 20, in accordance with an embodiment of the present teachings.

Referring to FIG. 6, the first processing unit 610 sends S602 a command to the second processing unit 410 through the first interface 700.

The first processing unit 610 may send S604 input data to the third memory unit 530 through the second interface 800.

For an embodiment, a speed at which the second processing unit 410 accesses the second memory unit 430 is faster than a speed at which the second processing unit 410 accesses the third memory unit 530 through the third interface 900. Accordingly, the second memory unit 430 may operate as a cache memory of the second processing unit 410, and the third memory unit 530 may operate as a main memory of the second processing unit 410. Such a memory hierarchy may improve processing performance of the second processing unit 410.

The second processing unit 410 may receive S606 the input data from the third memory unit 530.

The second processing unit 410 processes S608 the input data received from the third memory unit 530 in response to the command. The second processing unit 410 may cache the input data in the second memory unit 430 to access the input data rapidly. The input data may be processed in parallel by the plurality of operating cores included in the second processing unit 410.

When data processing of the second processing unit 410 is completed, process data generated by the data processing may be sent S610 to the third memory unit 530.

As described above, the first processing unit 610 may access a register of the assistant card 400 through the MMIO and recognize that the data processing is completed.

As the second processing unit 410 sends an interruption to the first processing unit 610, the second processing unit 410 may notify the first processing unit 610 that the data processing is completed.

The first processing unit 610 may receive S612 the process data through the second interface 800 and store S612 the process data in the first memory unit 630. Consequently, the parallel data processing operation of the data processing system 20 is completed.

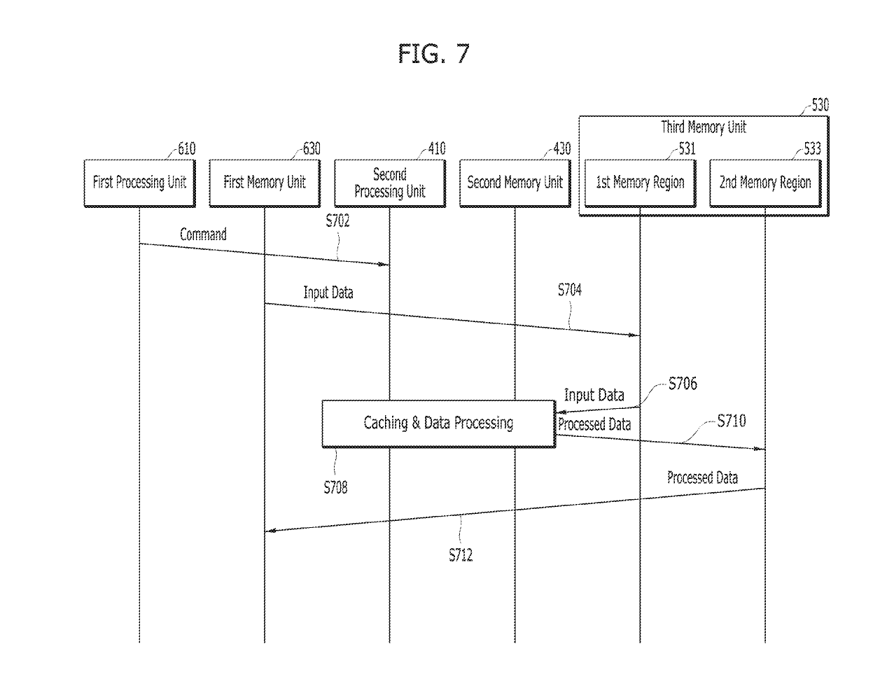

FIG. 7 shows a flow diagram illustrating a parallel data processing operation of the data processing system 20, in accordance with an embodiment of the present teachings.

Referring to FIG. 7, the first processing unit 610 sends S702 a command to the second processing unit 410 through the first interface 700.

The first processing unit 610 may send S704 input data to the first memory region 531 of the third memory unit 530 through the second interface 800.

The second processing unit 410 may receive S706 the input data from the first memory region 531.

The second processing unit 410 processes S708 the input data received from the first memory region 531 in response to the command. The second processing unit 410 may cache the input data in the second memory unit 430 to access the input data rapidly. The input data may be processed in parallel by the plurality of operating cores included in the second processing unit 410.

When processing of the input data is completed, the second processing unit 410 may send S710 process data generated by the processing the input data to the second memory region 533 of the third memory unit 530.

As described above, the first processing unit 610 may access a register of the expanded card 500 through the MMIO and recognize that the process data is stored in the second memory region 533.

As the expanded memory controller sends an interruption to the first processing unit 610, the expanded memory controller may notify the first processing unit 610 that the process data is stored in the second memory region 533.

The first processing unit 610 may receive S712 the process data through the second interface 800 and store S712 the process data in the first memory unit 630.

According to an embodiment of the present teachings, the first processing unit 610 may receive the process data stored in the second memory region 533 even during the processing of the input data.

Consequently, the parallel data processing operation of the data processing system 20 is completed.

In this case, similarly to the above descriptions made with reference to FIG. 5, the provision of the command and input data between the assistant card 400 and the main card 600 through the first interface 700 is not affected by provision of the process data. Therefore, performance of the data processing system 20 may be improved.

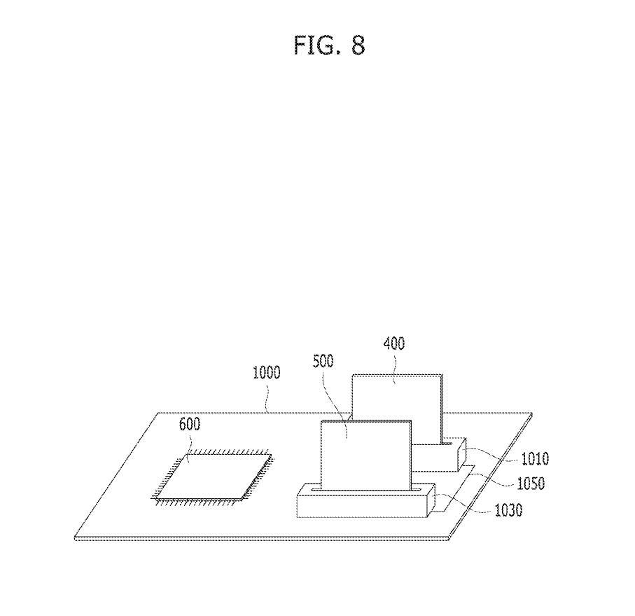

FIG. 8 shows a perspective diagram illustrating a physical configuration of the data processing system 20, in accordance with an embodiment of the present teachings.

Referring to FIG. 8, the main card 600 may be mounted on a main board 1000. For some embodiments, a main card being mounted on a main board means that a first processing unit of the main card coupled to the main board. For example, the first processing unit is wire bonded or soldered, using, for example, solder balls, to contacts on the main board, or the main processor is plugged into a socket, which, in turn, has contacts soldered or otherwise connected to the main board. In other embodiments, a main card includes a printed circuit board (PCB) on which a main processor is mounted. The PCB on which the main processor is mounted, in turn, is operationally connected to a main board through an expansion slot or another interface known in the art. In further embodiments, a first memory unit is coupled to a main board in the same manner as indicated above for the main processor. For example, the main processor unit and the first memory unit represent separate or combined integrated circuit apparatus which is or are connected directly to the main board (as pictured in FIGS. 8, 9, and 10) or coupled to the main board via a PCB card which is connected to the main board. The assistant card 400 and the expanded card 500 may be mounted in an assistant slot and an expanded slot, respectively, on the main board 1000. In FIG. 8, a first slot 1010 corresponds to the assistant slot, and a second slot 1030 corresponds to the expanded slot.

According to an embodiment of the present teachings, the first slot 1010 and the second slot 1030 may be PCIe slots.

The assistant card 400 and the main card 600 may communicate with each other through the assistant slot. In other words, the first interface 700 may be formed by the assistant slot.

The expanded card 500 and the main card 600 may communicate with each other through the expanded slot. In other words, the second interface 800 may be formed by the expanded slot.

An interface 1050 for coupling the assistant card 400 and the expanded card 500 may exist. In other words, the third interface 900 may be formed by the interface 1050.

According to an embodiment of the present teachings, the main board 1000 may be in a form of a printed circuit board (PCB), and the interface 1050 may be printed on the printed circuit board.

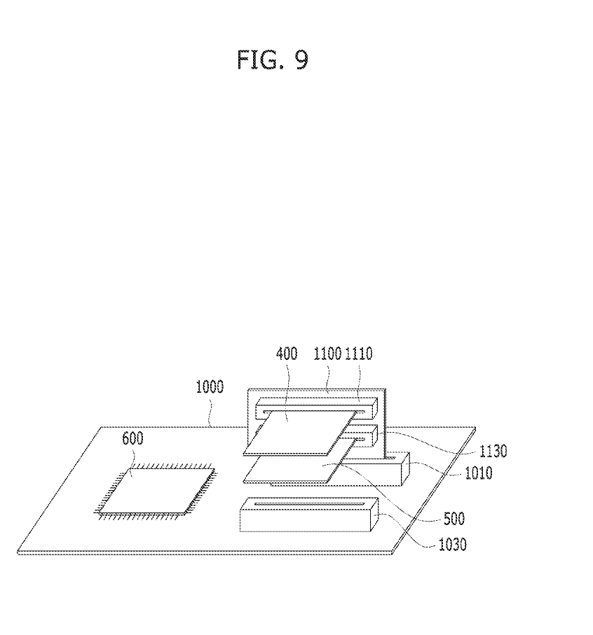

FIG. 9 shows a perspective diagram illustrating another physical configuration of the data processing system 20, in accordance with an embodiment of the present teachings.

Referring to FIG. 9, the main card 600 may be mounted on a main board 1000. A riser card 1100 may be mounted in a riser card slot on the main board 1000. In FIG. 9, a first slot 1010 corresponds to the riser card slot. The riser card 1100 may include one or more additional slots capable of mounting other cards therein.

The assistant card 400 and the expanded card 500 may be mounted in an assistant slot and an expanded slot, respectively, on the riser card 1100. In FIG. 9, a third slot 1110 corresponds to the assistant slot, and a fourth slot 1130 corresponds to the expanded slot. As shown, a second slot 1030 is unused. The assistant card 400 and the main card 600 may communicate with each other through the assistant slot and the riser card slot. In other words, the first interface 700 may be formed by the assistant slot and the riser card slot.

The expanded card 500 and the main card 600 may communicate with each other through the expanded slot and the riser card slot. In other words, the second interface 800 may be formed by the expanded slot and the riser card slot.

The assistant card 400 and the expanded card 500 may communicate with each other through the assistant slot and the expanded slot. In other words, the third interface 900 may be formed by the assistant slot and the expanded slot.

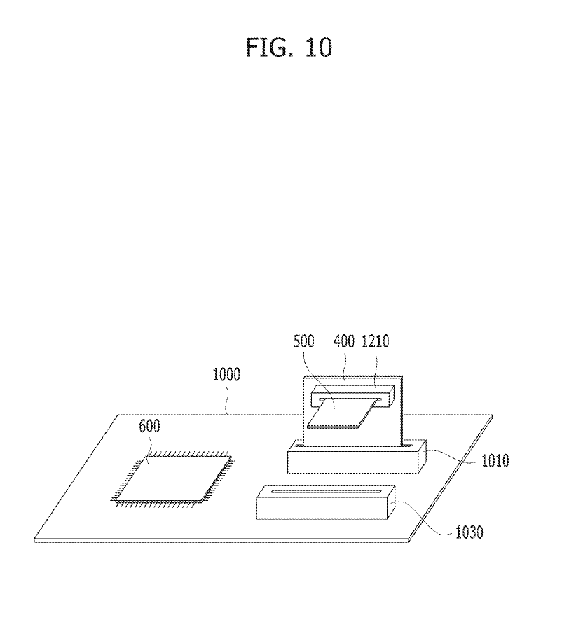

FIG. 10 shows a perspective diagram illustrating another physical configuration of the data processing system 20, in accordance with an embodiment of the present teachings.

Referring to FIG. 10, the main card 600 may be mounted on a main board 1000. The assistant card 400 may be mounted in an assistant slot on the main board 1000. In FIG. 10, a first slot 1010 corresponds to the assistant slot. The assistant card 400 may include a third slot 1210 corresponding to an expanded slot in which the expanded card 500 is mounted. The expanded card 500 may be directly coupled to the assistant card 400 through the expanded slot. As shown, the second slot 1030 is unused.

The assistant card 400 and the main card 600 may communicate with each other through the assistant slot. In other words, the first interface 700 may be formed by the assistant slot.

The expanded card 500 and the main card 600 may communicate with each other through the assistant slot and the expanded slot 1210. In other words, the second interface 800 may be formed by the assistant slot and the expanded slot.

The assistant card 400 and the expanded card 500 may communicate with each other through the expanded slot. In other words, the third interface 900 may be formed by the expanded slot.

According to embodiments of the present teachings, the second processing unit 410 may receive a large volume of input data from the first memory unit 630 and perform parallel data processing using the third memory unit 530 as well as the second memory unit 430. When a frequency with which data is received decreases due to an increase in a size of the received data, occurrence of the bottleneck phenomenon decreases so that overall performance of the data processing system 20 is improved, and an amount of data that an individual operating core of the second processing unit 410 can process increases so that an analysis capability of the data processing system 20 is improved.

According to embodiments of the present teachings, a data processing system capable of performing data processing with high performance is sent.

While the present teachings have been described with respect to specific embodiments, it will be apparent to those skilled in the art that various changes and modifications may be made to the presented embodiments without departing from the spirit and scope of the present teachings as defined by the following claims.

What is claimed is:

1. A data processing system comprising:
a main card comprising a first processing unit and a first memory unit;
an assistant card comprising a second processing unit and a second memory unit;
an expanded card comprising a third memory unit;
a first interface suitable for supporting communication between the main card and the assistant card;
a second interface suitable for supporting communication between the main card and the expanded card; and
a third interface suitable for supporting communication between the assistant card and the expanded card.

2. The data processing system of claim 1,
wherein the first processing unit sends a command to the second processing unit and sends input data to the third memory unit,
wherein the second processing unit receives the input data from the third memory unit, processes the input data in response to the command to generate process data, and sends to the third memory unit the process data, and
wherein the first processing unit receives the process data from the third memory unit.

3. The data processing system of claim 2,
wherein the third memory unit comprises first and second memory regions,
wherein the first processing unit sends the input data to the first memory region,
wherein the second processing unit receives the input data from the first memory region and sends the process data to the second memory region, and
wherein the first processing unit receives the process data from the second memory region.

4. The data processing system of claim 1,
wherein the first processing unit sends a command to the second processing unit, sends first input data to the second memory unit, and sends second input data to the third memory unit,
wherein, in response to the command, the second processing unit receives the first input data from the second memory unit and processes the first input data to generate first process data, receives the second input data from the third memory unit and processes the second input data to generate second process data, sends the first process data to the second memory unit, and sends the second process data to the third memory unit, and
wherein the first processing unit receives the first process data from the second memory unit and receives the second process data from the third memory unit.

5. The data processing system of claim 1,
wherein the third memory unit comprises first and second memory regions,
wherein the first processing unit sends a command to the second processing unit, sends first input data to the second memory unit, and sends second input data to the first memory region,
wherein, in response to the command, the second processing unit receives the first input data from the second memory unit and processes the first input data to generate first process data, receives the second input data from the first memory region and processes the second input data to generate second process data, and sends the first and second process data to the second memory region, and
wherein the first processing unit receives the first and second process data from the second memory region.

6. The data processing system of claim 1, wherein the main card is mounted on a main board, the assistant card is mounted on the main board through an assistant slot, and the expanded card is mounted on the main board through an expanded slot.

7. The data processing system of claim 1, wherein the main card is mounted on a main board, the assistant card is mounted in an assistant slot included in a riser card, the expanded card is mounted in an expanded slot included in the riser card, and the riser card is mounted on the main board through a riser card slot.

8. The data processing system of claim 1, wherein the main card is mounted on a main board, the assistant card is mounted on the main board through an assistant slot, and the expanded card is mounted on the assistant card through an expanded slot.

9. An operating method of a data processing system, the method comprising:
sending, by a first processing unit of the data processing system, a command to a second processing unit of the data processing system through a first interface and sending, by the first processing unit, input data to a third memory unit of the data processing system through a second interface;
receiving, by the second processing unit, the input data from the third memory unit through a third interface, processing the input data in response to the command to generate process data, and sending the process data to the third memory unit through the third interface; and
receiving, by the first processing unit, the process data from the third memory unit through the second interface.

10. The operating method of claim 9,
wherein the third memory unit comprises first and second memory regions,
wherein sending the input data to the third memory unit comprises sending the input data to the first memory region,
wherein the receiving the input data comprises receiving the input data from the first memory region and wherein sending the process data comprises sending the process data to the second memory region, and
wherein receiving the process data comprises receiving the process data from the second memory region.

11. An operating method of a data processing system, the method comprising:
sending, by a first processing unit of the data processing system, a command to a second processing unit of the data processing system through a first interface, sending, by the first processing unit, first input data to a second memory unit of the data processing system through the first interface, and sending, by the first processing unit, second input data to a third memory unit of the data processing system through a second interface;
receiving, by the second processing unit in response to the command, the first input data from the second memory unit, processing the first input data to generate the first process data, and sending the first process data to the second memory unit;
receiving, by the second processing unit through the third interface in response to the command, the second input data from the third memory unit, processing the second input data to generate second process data, and sending the second process data to the third memory unit; and
receiving, by the first processing unit, the first process data from the second memory unit through the first interface and receiving, by the first processing unit, the second process data from the third memory unit through the second interface.

12. An operating method of a data processing system comprising a third memory unit including first and second memory regions, the operating method comprising:
sending, by a first processing unit of the data processing system, a command to a second processing unit of the data processing system through a first interface, sending first input data to a second memory unit of the data processing system through the first interface, and sending second input data to the first memory region through a second interface;
receiving, by the second processing unit in response to the command, the first input data from the second memory unit, processing the first input data to generate the first process data, and sending the first process data to the second memory unit;
receiving, by the second processing unit through the third interface in response to the command, the second input data from the first memory region, process the second input data to generate second process data, and sending the second process data to the second memory region; and
receiving, by the first processing unit, the first and second process data from the second memory region through the second interface.
